(19) United States
(12) Patent Application Publication
(10) Pub. No.: US 2008/0150886 A1
(43) Pub. Date: Jun. 26, 2008

(54) Electrophoretic Display Panel

(75) Inventors: Mark Thomas Johnson, Eindhoven (NL); Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,989

(22) PCT Filed: Feb. 15, 2005
(86) PCT No.: PCT/IB2005/050580

§ 371 Date: Aug. 15, 2006

(30) Foreign Application Priority Data
Feb. 19, 2004 (EP) 04100659.4

(51) Int. Cl. G09G 3/34

(52) U.S. Cl. 345/107

(57) ABSTRACT

An electrophoretic display panel (1), comprises a plurality of picture elements (2); and drive means (100), for providing reset pulses prior to application of grey scale pulses and for providing shaking potential differences in between application of reset and grey scale potential differences. The display panel comprises two or more interspersed groups of display elements. Each group is supplied with its own application scheme (1, II) of shaking potential differences, the application schemes for shaking potential differences differ from group to group in such manner that the occurrence of shaking potential difference differs between said groups for at least some transitions.

The invention relates to an electrophoretic display panel, comprising:
an electrophoretic medium comprising charged particles;
a plurality of picture elements;
electrodes associated with each picture element for receiving a potential difference,
   the charged particles being able to occupy extreme positions near the electrodes and intermediate positions in between the electrodes; the extreme positions being associated with extreme optical states; and
drive means,
   the drive means being arranged for providing to each of the plurality of picture elements:
a reset potential difference having a reset value and a reset duration during a reset period for causing the charged particles to substantially occupy one of the extreme positions, and thereafter
a grey scale potential difference for causing the particles to occupy the position corresponding to image information and
a series of shaking potential differences during a shaking period in between application of the reset potential difference and the grey scale potential difference.

The invention also relates to a method for driving an electrophoretic display devices comprising a plurality of picture elements in which method reset potential difference are applied to picture elements of the display device, prior to application of grey scale potentials differences to said picture elements and wherein in between application of a reset potential difference and a grey scale potential difference a series of shaking potential difference is applied.

An embodiment of the electrophoretic display panel of the type mentioned in the opening paragraph is described in International Patent Application WO 03/079323.

In the described electrophoretic display panel, each picture element has, during the display of the picture, an appearance determined by the position of the particles. The position of the particles depends, however, not only on the potential difference but also on the history of the potential difference. As a result of the application of the reset potential difference the dependency of the appearance of the picture element on the history is reduced, because particles substantially occupy one of the extreme positions before a grey scale potential difference is applied. Thus the picture elements are each time reset to one of the extreme states. Within the frame-work of the invention the “reset” stands for application of a potential difference sufficient to bring an element into an extreme state, but not longer than necessary to do so, i.e. the reset pulse is long enough to bring the element into an extreme state but substantially no longer than necessary to bring the element into an extreme state. Subsequently, as a consequence of the picture potential difference, the particles occupy the position to display the grey scale corresponding to the image information. “Grey scale” is to be understood to mean any intermediate state. When the display is a black and white display, “grey scale” indeed relates to a shade of grey, when other types of colored elements are used ‘grey scale’ is to be understood to encompass any intermediate state in between extreme states.

When the image information is changed the picture elements are reset. In between application of the reset potential difference and the grey scale potential difference a series of shaking potential differences is applied. In WO 03/079323 these potential differences are called “preset potential differences”. A shaking potential difference comprises a pulse with an energy sufficient to release the electrophoretic particle from a static state at one of the two electrodes, but too low too reach the other one of the electrodes. The underlying mechanism can be explained because after the display device is switched to a predetermined state e.g. a black state, the electrophoretic particles become in a static state, when a subsequent switching is to the white state, a momentum of the particles is low because their starting speed is close to zero. This results in a long switching time. The application of the shaking (or “preset”) pulses increases the momentum of the electrophoretic particles and thus shortens the switching time.

Despite the beneficial effect of application of the shaking (or “preset”) potential differences, the inventors have realized that they also a negative effect during the change-over from one image to another at the end of the reset period. When a grey-scale image is reset a purely black-and-white image is produced. This black-and-white image is retained during application of the shaking potential differences. Thus, during a period a visible harsh black-and-white image is visible. This transition from one image having grey tones to another image having grey tones via a purely black-and-white image which harsh, grey toneless image is visible during some time is disturbing to the viewer.

It is an object of the invention to provide a display panel of the kind mentioned in the opening paragraph which is able to provide a more appealing change-over from one image to another.

The object is thereby achieved that the plurality of picture elements comprises two or more interspersed groups of picture elements, and in that the drive means are arranged for providing each group of picture elements with its own application scheme of shaking potential differences, the application schemes of shaking potential differences differing from group to group in such a manner that the shaking time periods at which the shaking potential difference are applied to said groups do not, during a time difference, completely coincide for at least some transitions of a picture element from an initial optical state to a final optical state via an extreme optical state, the time difference being at least 25% of the longest shaking time period for the respective groups. The time difference may be due to a difference in the onset time of the shaking potential differences, a termination time of the shaking potential differences, i.e. the start or end of the shaking time periods, especially in case the shaking time period for the groups are of the same length, or in the case of shaking potential differences with different duration either the onset or the termination time or both.

Resetting the picture elements to one of the extreme states requires for different picture elements the application of a reset potential. When all elements are reset to a black and white image is produced. Thereafter shaking pulses, during the shaking time period, are applied and thereafter the grey scale potential differences are applied.

The concept of the invention is to split the display panel and therewith the image displayed on the display panel into two or more groups of elements. For each of the groups of elements this disturbing effect occurs. However, the total image is comprised of two or more intermixed images and the sum of the effects of the groups alleviates or at least reduces the effect. To do so the period during which a pure black and white image, i.e. during application of the shaking pulses, is visible differs from group to group, i.e. the shaking time period do not completely coincide and the difference, i.e. the time during which the shaking period do not coincide is a substantial part (at least 25%, in preferred embodiment at least 50%, in most preferred embodiment more than 75%, preferably 100%) of the length of time during which the black and white image is visible, and the groups are interspersed, i.e. when viewed by a viewer from a normal viewing distances (i.e. not using a magnifying glass or other such device) the images produced by the different groups fuse into one image. Each of the groups, when seen on its own, produces the disturbing effect of showing a harsh purely black-and-white image in between grey tones comprising images. However, since the periods in which this effect is visible differ from group to group, for at least some of the transitions, and the groups are interspersed, forming one single image for the human eye, the human eye averages the effects of the groups into a composite, less disturbing, effect, and a more smooth image change-over results. “Interspersed” means that when seen by a viewer from a normal or standard viewing distances (roughly 3 times or more the diagonal dimension of the screen) the images by the individual groups fuse into one image. Some examples of such interspersed groups are for instance groups wherein even rows or even columns belong to one group, and the odd rows or columns belong to another group. The size of the columns and rows of display devices is such that at usual viewing distances they are not individually distinguishable by a viewer, therefore a division in groups comprising adjacent rows will fuse the two images into one image. Groups may also comprises pairs of columns or rows or alternating bundles comprising a small number (1, 2, 3 or 4) of columns or rows, if the dimensions of the rows and columns are small enough. Also a checker-board pattern of small dimensions may be used. Non-interspersed groups are for instance groups wherein one group comprises the left hand half of the display screen, and the other the right hand half, or one group comprises the upper half of the display screen and the other the lower half. Such groups cover different parts of the display screen and the viewer will simply see the same effect twice, only slightly different on the upper (right hand) half, then on the lower (left hand) half. To enable an effective smoothing effect the time difference is at least 25%, preferably 50% or more than the time during which the black-and-white image is visible.

Preferably the drive means are arranged such that the application schemes for application of the shaking potential differences alternate between groups of picture elements between frames.

The application of shaking signals that differ between groups, has the above described positive effect of reducing the harshness of the image change-over. However, although application of the shaking pulses in different schemes for different groups has a positive effect, it is best if, seen on a longer time scale, all groups of elements have substantially the same history of application of shaking potential differences. By alternating the schemes for application of shaking potential difference between the groups of picture elements between images, the differences between the groups of picture elements are minimized. So, if for instance two groups of picture elements (A, B) are used, and two application schemes I and II are used for application of shaking potential difference, in the first frame scheme I is used for group A, and scheme II for group B, and in the next frame scheme II for group A and scheme II for group B, returning to scheme I for group A and scheme II for group B in the next frame etc. With more than two groups permutation or rotation of the schemes would be used, which within the concept of the invention falls under “alternating”. Within preferred embodiments the schemes are alternated with each change of a frame, however, within the broader concept of the invention, the schemes may be alternated each n frames, wherein n is a small number such as 1, 2, 3.

In one embodiment the drive means are arranged to supply each group with its own scheme of shaking potential differences, the application schemes for shaking potential differences differing from group to group only by a time difference independent of the transition.

In this embodiment a time difference (delay) is established between application of the shaking potential differences. The application schemes are for each group basically the same, but are shifted in time by a delay. The application of pulses starts and ends at different times for the different groups. This is a simple embodiment, requiring not much more than a simple waveform delay which is the same for each waveform.

Further embodiments with different duration of the shaking potential differences in different groups and/or differing for different transitions are given in the examples.

In the method in accordance with the invention the method is characterized in that reset potential differences are applied to picture elements of the display device, prior to application of grey scale potential differences to said picture elements, wherein in between application of reset potential difference and grey scale potential difference shaking potential differences are applied during a shaking time period, wherein the plurality of picture elements comprises two or more interspersed groups of picture elements, and wherein each group of picture elements is supplied with its own application scheme of shaking potential differences, the application schemes for shaking potential differences differing from group to group in such manner that the shaking time periods at which shaking potential differences are applied to said groups do not, during a time difference (Δ) completely coincide for at least some transitions of a picture element from an initial optical state to a final optical state via an extreme optical state, the time difference being at least 25% of the longest shaking time period for the respective groups.

These and other aspects of the display panel of the invention will be further elucidated and described with reference to the drawings, in which:

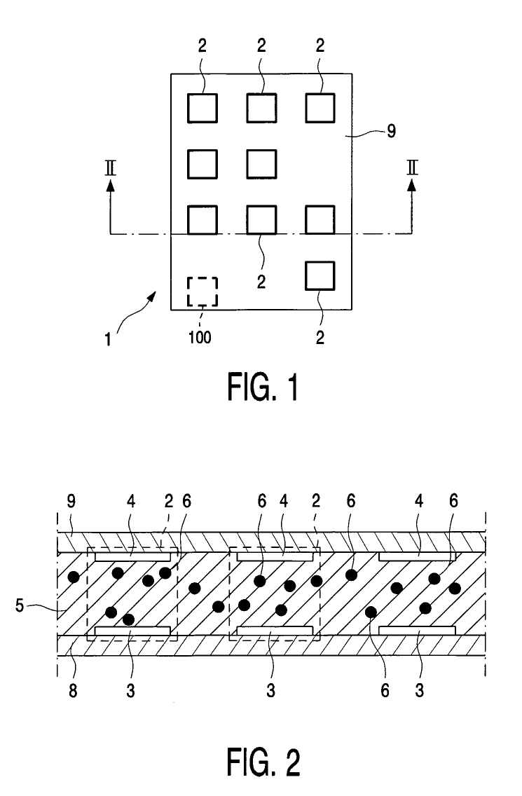

FIG. 1 shows diagrammatically a front view of an a display panel;

FIG. 2 shows diagrammatically a cross-sectional view along II-II in FIG. 1;

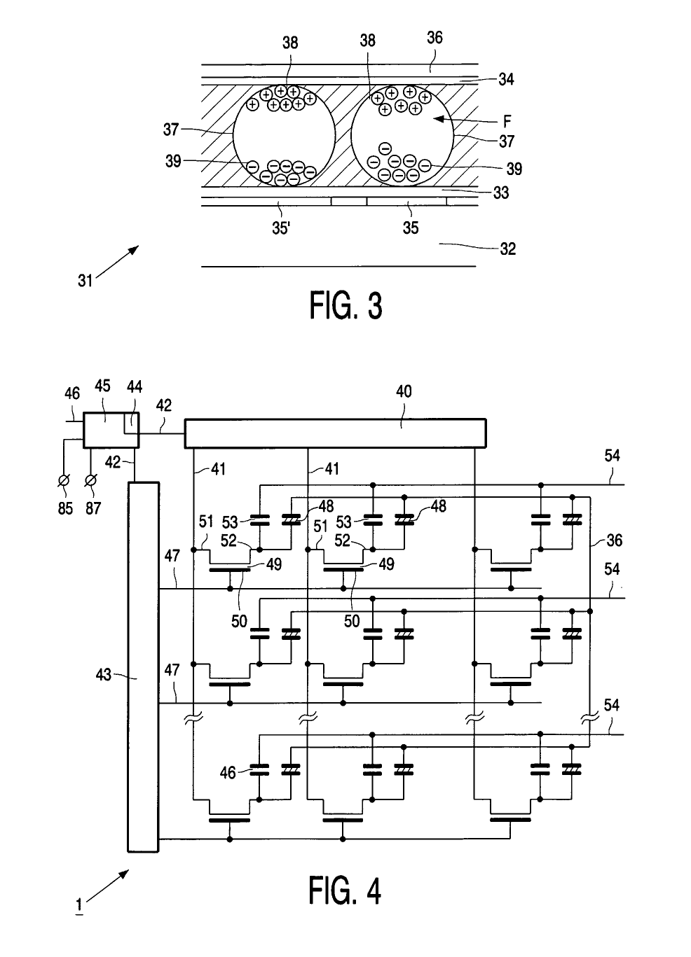

FIG. 3 shows diagrammatically a cross section of a portion of a further example of an electrophoretic display device;

FIG. 4 shows diagrammatically an equivalent circuit of a picture display device of FIG. 3;

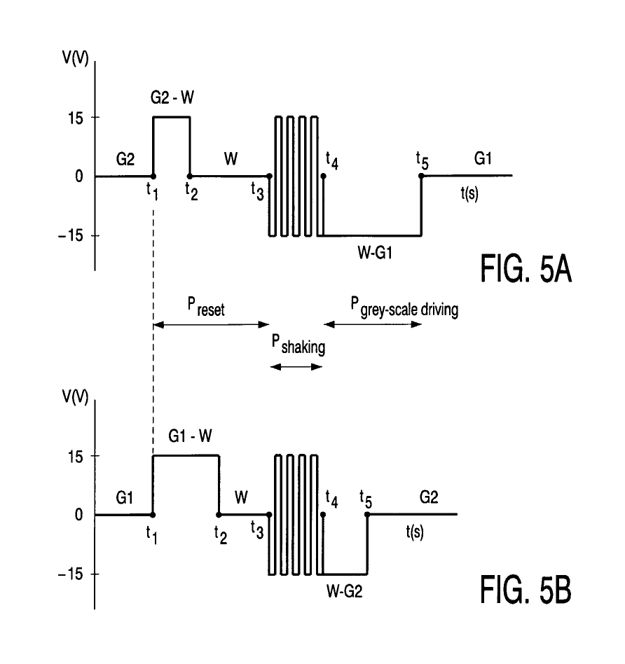

FIG. 5A shows diagrammatically the potential difference as a function of time for a picture element for one transition;

FIG. 5B shows diagrammatically the potential difference as a function of time for a picture element for a further transition;

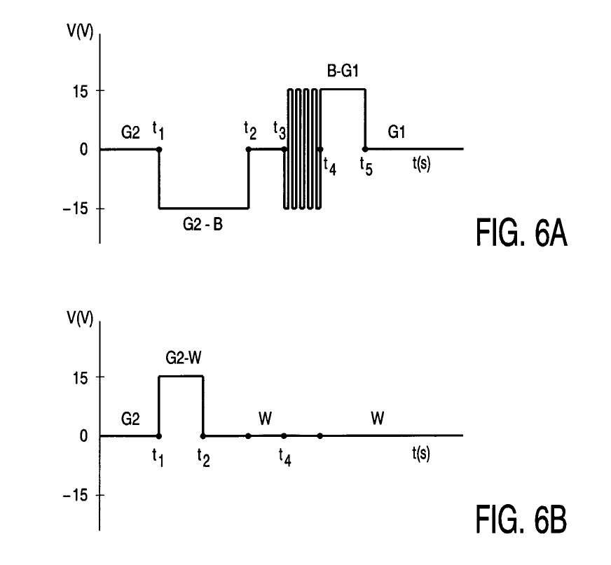

FIG. 6A shows diagrammatically the potential difference as a function of time for a picture element for a further transition;

FIG. 6B shows diagrammatically the potential difference as a function of time for another picture element for a further transition;

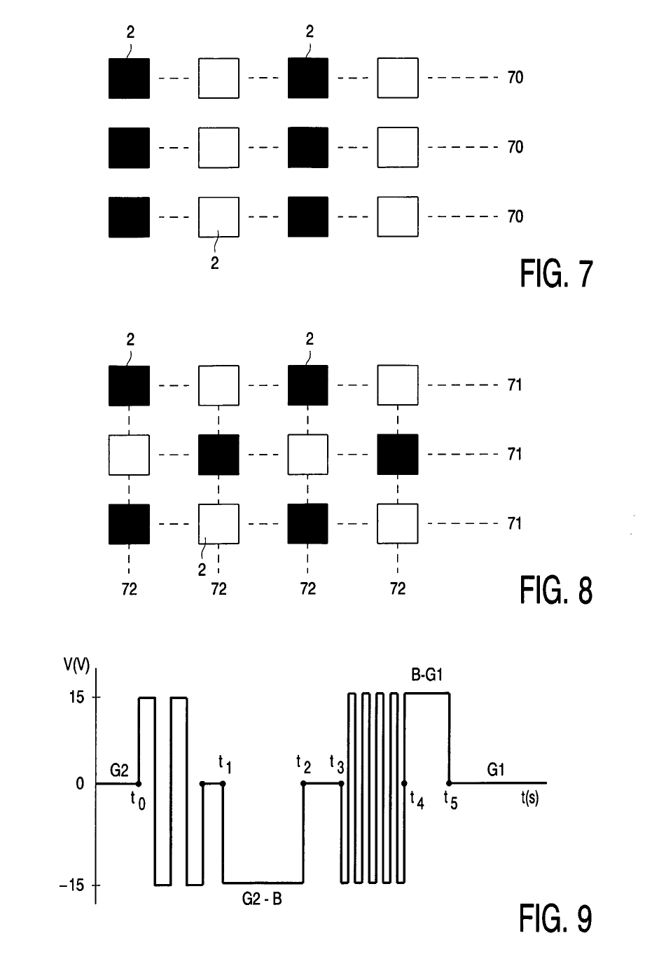

FIG. 7 shows the picture representing an average of the first and the second appearances as a result of the reset potential differences, and

FIG. 8 shows the picture representing an average of the first and the second appearances as a result of the reset potential differences;

FIG. 9 shows diagrammatically the potential difference as a function of time for a picture element;

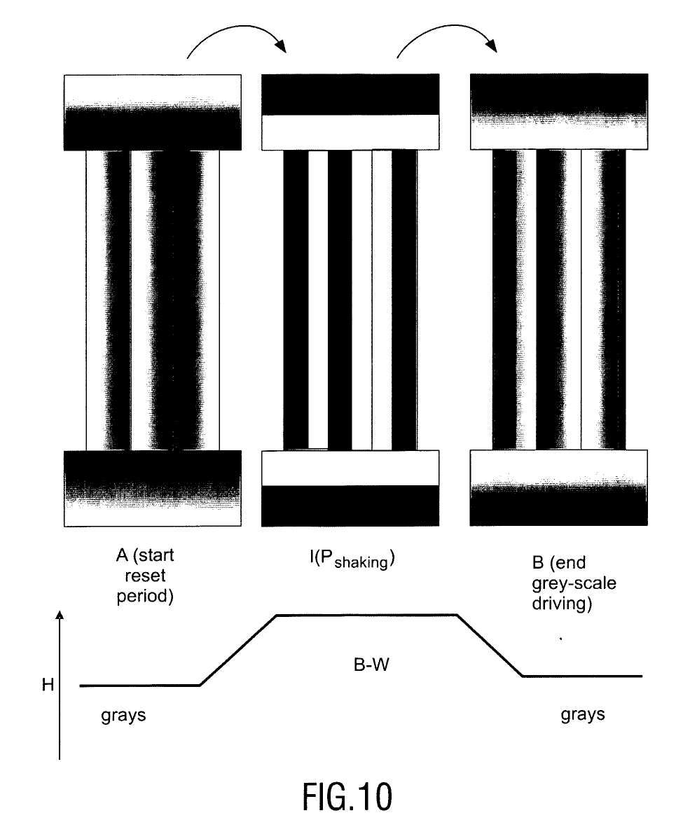

FIG. 10 illustrate a transition from an initial grey tone image A to a next grey tone image B, via an intermediate black-and-white image I;

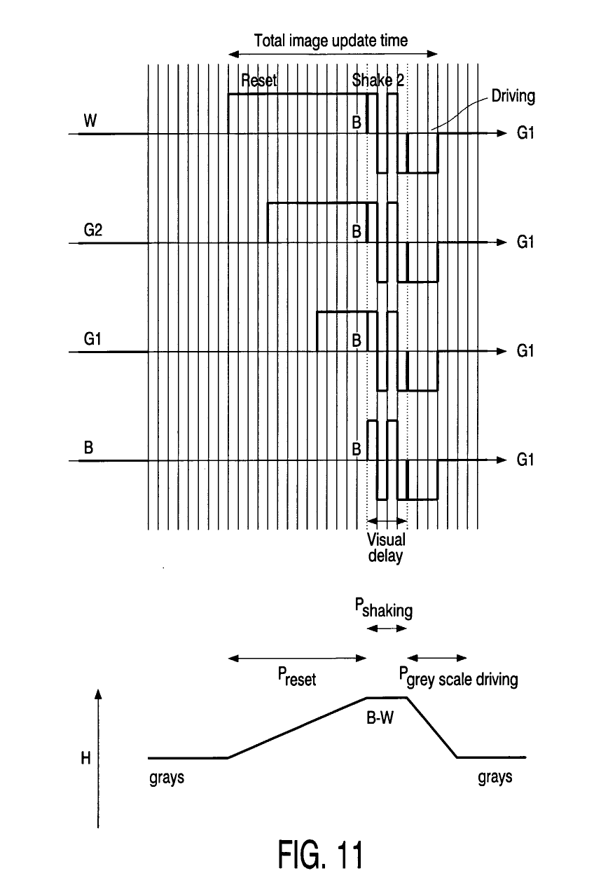

FIG. 11 illustrates a first driving scheme;

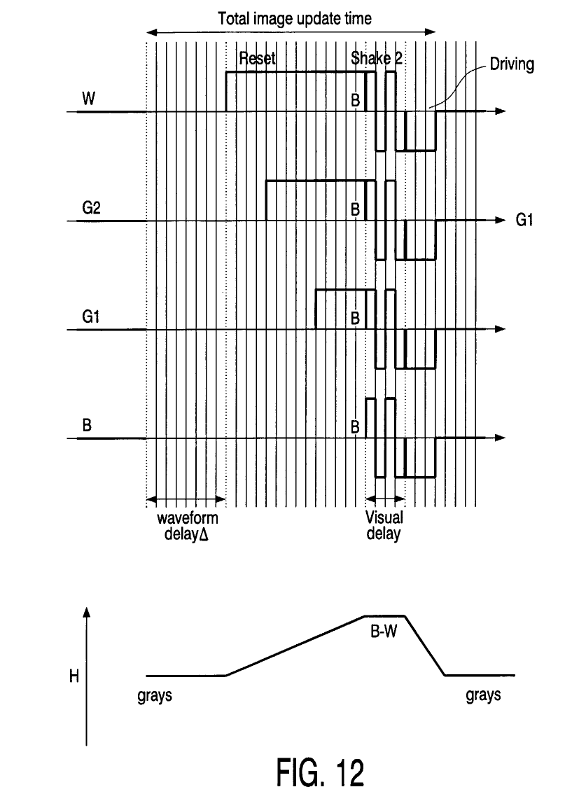

FIG. 12 illustrates a second driving scheme differing from the driving scheme of FIG. 11 in that a delay time Δ is added;

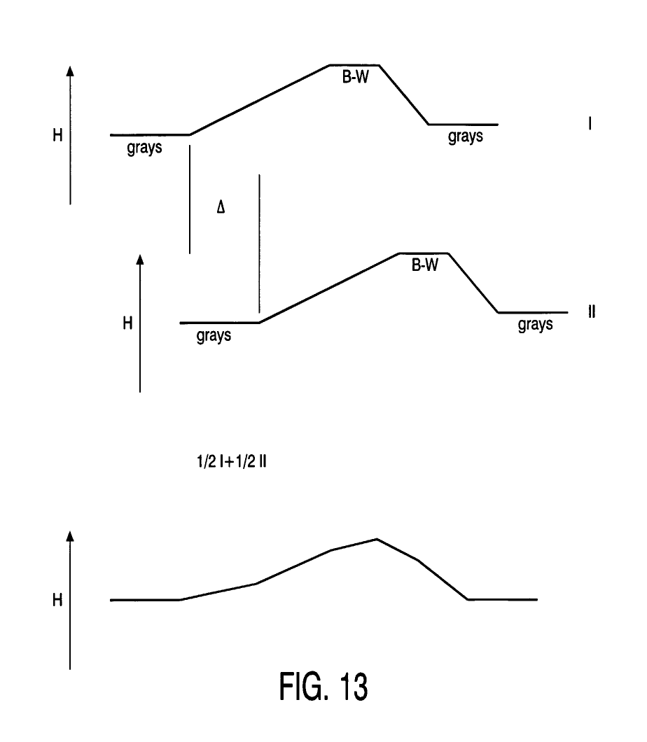

FIG. 13 illustrates the effect of two interspersed groups using the schemes of FIGS. 11 and 12;

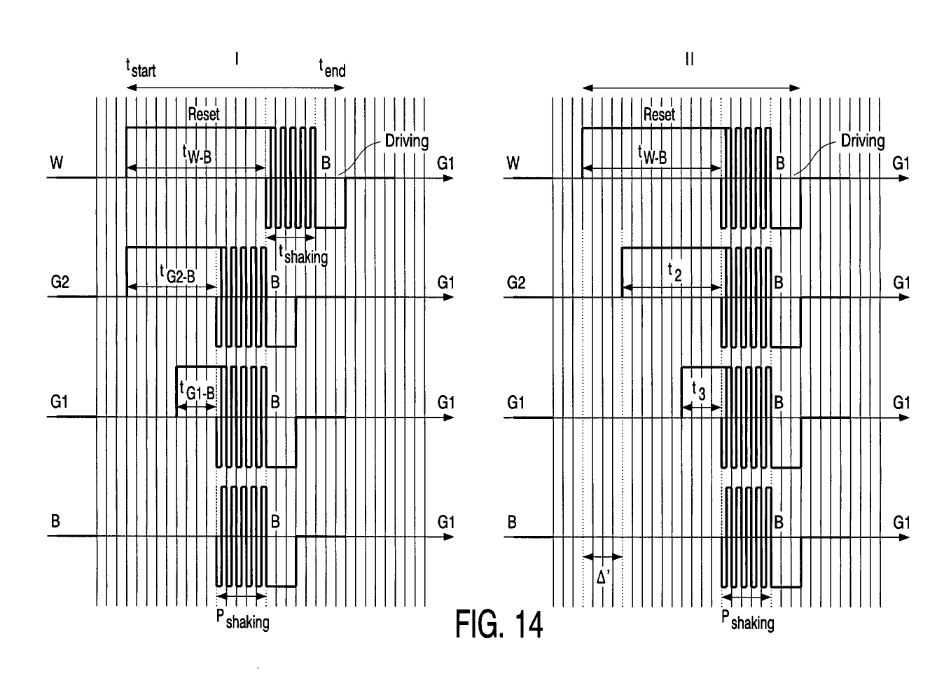

FIG. 14 illustrates a further embodiment of the invention;

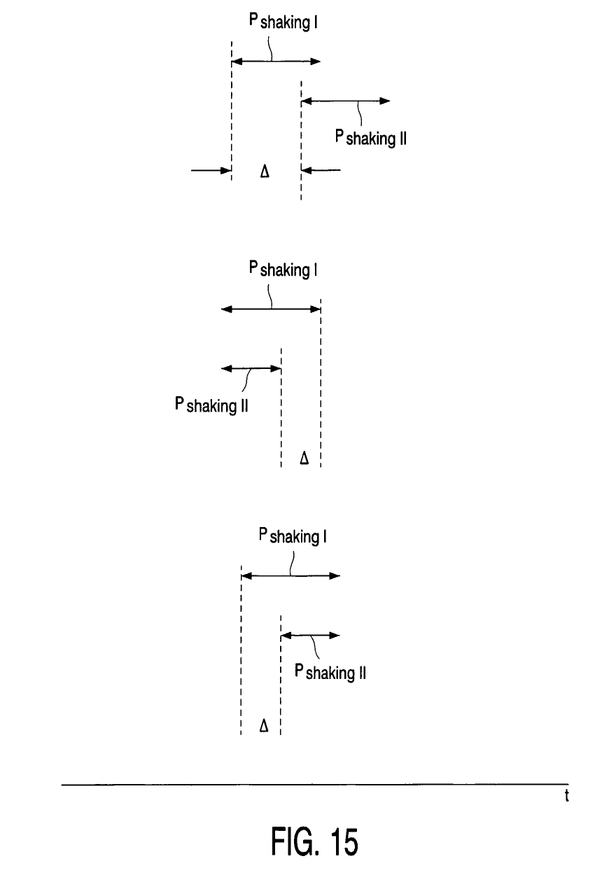

FIG. 15 illustrates different relation between shaking period times.

In all the Figures corresponding parts are usually referenced to by the same reference numerals.

FIGS. 1 and 2 show an embodiment of the display panel 1 having a first substrate 8, a second opposed substrate 9 and a plurality of picture elements 2. Preferably, the picture elements 2 are arranged along substantially straight lines in a two-dimensional structure. Other arrangements of the picture elements 2 are alternatively possible, e.g. a honeycomb arrangement. An electrophoretic medium 5, having charged particles 6, is present between the substrates 8, 9. A first and a second electrode 3, 4 are associated with each picture element 2. The electrodes 3, 4 are able to receive a potential difference. In FIG. 2 the first substrate 8 has for each picture element 2 a first electrode 3, and the second substrate 9 has for each picture element 2 a second electrode 4. The charged particles 6 are able to occupy extreme positions near the electrodes 3, 4 and intermediate positions in between the electrodes 3, 4. Each picture element 2 has an appearance determined by the position of the charged particles 6 between the electrodes 3, 4 for displaying the picture. Electrophoretic media 5 are known per se from e.g. U.S. Pat. No. 5,961,804, U.S. Pat. No. 6,120,839 and U.S. Pat. No. 6,130,774 and can e.g. be obtained from E Ink Corporation. As an example, the electrophoretic medium 5 comprises negatively charged black particles 6 in a white fluid. When the charged particles 6 are in a first extreme position, i.e. near the first electrode 3, as a result of the potential difference being e.g. 15 Volts, the appearance of the picture element 2 is e.g. white. Here it is considered that the picture element 2 is observed from the side of the second substrate 9. When the charged particles 6 are in a second extreme position, i.e. near the second electrode 4, as a result of the potential difference being of opposite polarity, i.e. −15 Volts, the appearance of the picture element 2 is black. When the charged particles 6 are in one of the intermediate positions, i.e. in between the electrodes 3, 4, the picture element 2 has one of the intermediate appearances, e.g. light gray, middle gray and dark gray, which are gray levels between white and black. The drive means 100 are arranged for controlling the potential difference of each picture element 2 to be a reset potential difference having a reset value and a reset duration for enabling particles 6 to substantially occupy one of the extreme positions, and subsequently to be a picture potential difference for enabling the particles 6 to occupy the position corresponding to the image information.

FIG. 3 diagrammatically shows a cross section of a portion of a further example of an electrophoretic display device 31, for example of the size of a few display elements, comprising a base substrate 32, an electrophoretic film with an electronic ink which is present between two transparent substrates 33, 34 for example polyethylene, one of the substrates 33 is provided with transparent picture electrodes 35 and the other substrate 34 with a transparent counter electrode 36. The electronic ink comprises multiple micro capsules 37, of about 10 to 50 microns. Each micro capsule 37 comprises positively charged white particles 38 and negative charged black particles 39 suspended in a fluid F. When a positive field is applied to the pixel electrode 35, the white particles 38 move to the side of the micro capsule 37 directed to the counter electrode 36 and the display element become visible to a viewer. Simultaneously, the black particles 39 move to the opposite side of the microcapsule 37 where they are hidden to the viewer. By applying a negative field to the pixel electrodes 35, the black particles 39 move to the side of the micro capsule 37 directed to the counter electrode 36 and the display element become dark to a viewer (not shown). When the electric field is removed the particles 38, 39 remain in the acquired state and the display exhibits a bi-stable character and consumes substantially no power. The particles may be black and white, but may be also be colored. In this respect it is remarked that “grey scale” is to be understood to mean any intermediate state. When the display is a black and white display, “grey scale” indeed relates to a shade of grey, when other types of colored elements are used ‘grey scale’ is to be understood to encompass any intermediate state in between extreme states.

FIG. 4 shows diagrammatically an equivalent circuit of a picture display device 31 comprising an electrophoretic film laminated on a base substrate 32 provided with active switching elements, a row driver 46 and a column driver 40. Preferably, a counter electrode 36 is provided on the film comprising the encapsulated electrophoretic ink, but could be alternatively provided on a base substrate in the case of operation using in-plane electric fields. The display device 31 is driven by active switching elements, in this example thin film transistors 49. It comprises a matrix of display elements at the area of crossing of row or selection electrodes 47 and column or data electrodes 41. The row driver 46 consecutively selects the row electrodes 47, while a column driver 40 provides a data signal to the column electrode 41. Preferably, a processor 45 firstly processes incoming data 43 into the data signals. Mutual synchronization between the column driver 40 and the row driver 46 takes place via drive lines 42. Select signals from the row driver 46 select the pixel electrodes 42 via the thin film transistors 49 whose gate electrodes 50 are electrically connected to the row electrodes 47 and the source electrodes 51 are electrically connected to the column electrodes 41. A data signal present at the column electrode 41 is transferred to the pixel electrode 52 of the display element coupled to the drain electrode via the TFT. In the embodiment, the display device of FIG. 3 also comprises an additional capacitor 53 at the location at each display element 48. In this embodiment, the additional capacitor 53 is connected to one or more storage capacitor lines 54. Instead of TFT other switching elements can be applied such as diodes, MIM's, etc.

As an example the appearance of a picture element of a subset is light gray, denoted as G2, before application of the reset potential difference. Furthermore, the picture appearance corresponding to the image information of the same picture element is dark gray, denoted as G1. For this example, the potential difference of the picture element is shown as a function of time in FIG. 5A. The reset potential difference has e.g. a value of 15 Volts and is present from time t₁ to time t₂, t₃ being the maximum reset duration, i.e. the reset period Pᵣₑₛₑₜ. The reset duration and the maximum reset duration are e.g. 50 ms and 300 ms, respectively. As a result the picture element has an appearance being substantially white, denoted as W. The picture potential difference (grey scale potential difference) is present from time t₄ to time t₅ (P_{grey-scale driving}) and has a value of e.g. −15 Volts and a duration of e.g. 150 ms. As a result the picture element has an appearance being dark gray (G1), for displaying the picture. In between application of the reset potential difference and the grey scale potential difference a series of shaking potential difference is applied between t₃ and t₄, indicated in the figure by P_{shaking}.

As a further example the potential difference of a picture element is shown as a function of time in FIG. 5B. The appearance of the picture element is dark gray (G1) before application of the reset potential difference. Furthermore, the picture appearance corresponding to the image information of the picture element is light gray (G2). The reset potential difference has e.g. a value of 15 Volts and is present from time t₁ to time t₂. The reset duration is e.g. 150 ms. As a result the picture element has an appearance being substantially white (W). The grey scale or picture potential difference is present from time t₄ to time t₅ (P_{grey scale driving}) and has e.g. a value of e.g. −15 Volts and a duration of e.g. 50 ms. As a result the picture element has an appearance being light gray (G2), for displaying the picture. During the shaking period P_{shaking} a series of shaking potential difference is applied.

In another variation of the embodiment the drive means 100 are further arranged for controlling the reset potential difference of each picture element to enable particles 6 to occupy the extreme position which is closest to the position of the particles 6 which corresponds to the image information. As an example the appearance of a picture element is light gray (G2) before application of the reset potential difference. Furthermore, the picture appearance corresponding to the image information of the picture element is dark gray (G1). For this example, the potential difference of the picture element is shown as a function of time in FIG. 6A. The reset potential difference has e.g. a value of −15 Volts and is present from time t₁ to time t₂. The reset duration is e.g. 150 ms. As a result, the particles 6 occupy the second extreme position and the picture element has a substantially black appearance, denoted as B, which is closest to the position of the particles 6 which corresponds to the image information, i.e. the picture element 2 having a dark gray appearance (G1). The grey scale or picture potential difference is present from time t₄ to time t₅ and has e.g. a value of e.g. 15 Volts and a duration of e.g. 50 ms. Again, a series of shaking pulses is applied during P_{shaking}. As a result the picture element 2 has an appearance being dark gray (G1), for displaying the picture. As another example the appearance of another picture element is light gray (G2) before application of the reset potential difference. Furthermore, the picture appearance corresponding to the image information of this picture element is substantially white (W). For this example, the potential difference of the picture element is shown as a function of time in FIG. 6B. The reset potential difference has e.g. a value of 15 Volts and is present from time t₁ to time t₂. The reset duration is e.g. 50 ms. As a result, the particles 6 occupy the first extreme position and the picture element has a substantially white appearance (W), which is closest to the position of the particles 6 which corresponds to the image information, i.e. the picture element 2 having a substantially white appearance. The picture potential difference is present from time t₄ to time t₅ and has a value of 0 Volts because the appearance is already substantially white, for displaying the picture. In this case it is not necessary to use shaking pulses, the particles do not necessarily have to be shaken. {i.e. optional, could be if desired}. For transition in which the final grey scale is an extreme state (Black or white), it is not needed that a grey scale potential difference is applied after resetting, since the element is, after resetting, in the intended optical state. For such transitions, it is not needed, nor generally useful to use shaking pulses. For transitions in which the original optical state (i.e. before possible application of a reset pulse) equals the final state, it is not needed to use reset pulse, consequently there is no need for shaking pulses. Within the framework of the invention transitions are compared in the respective groups that do use shaking pulses, the periods P_{shaking} for groups are compared to each other, and a difference is determined.

In FIG. 7 the picture elements are arranged along substantially straight lines 70. The picture elements have substantially equal first appearances, e.g. white, if particles 6 substantially occupy one of the extreme positions, e.g. the first extreme position. The picture elements have substantially equal second appearances, e.g. black, if particles 6 substantially occupy the other one of the extreme positions, e.g. the second extreme position. The drive means are further arranged for controlling the reset potential differences of subsequent picture elements 2 along on each line 70 to enable particles 6 to substantially occupy unequal extreme positions. FIG. 7 shows the picture representing an average of the first and the second appearances as a result of the reset potential differences. The picture represents substantially middle gray.

In FIG. 8 the picture elements 2 are arranged along substantially straight rows 71 and along substantially straight columns 72 being substantially perpendicular to the rows in a two-dimensional structure, each row 71 having a predetermined first number of picture elements, e.g. 4 in FIG. 8, each column 72 having a predetermined second number of picture elements, e.g. 3 in FIG. 8. The picture elements have substantially equal first appearances, e.g. white, if particles 6 substantially occupy one of the extreme positions, e.g. the first extreme position. The picture elements have substantially equal second appearances, e.g. black, if particles 6 substantially occupy the other one of the extreme positions, e.g. the second extreme position. The drive means are further arranged for controlling the reset potential differences of subsequent picture elements 2 along on each row 71 to enable particles 6 to substantially occupy unequal extreme positions, and the drive means are further arranged for controlling the reset potential differences of subsequent picture elements 2 along on each column 72 to enable particles 6 to substantially occupy unequal extreme positions. FIG. 8 shows the picture representing an average of the first and the second appearances as a result of the reset potential differences. The picture represents substantially middle gray, which is somewhat smoother compared to the previous embodiment.

In variations of the device the drive means are further arranged for controlling the potential difference of each picture element to be a sequence of preset potential differences before being the reset potential difference. Preferably, the sequence of preset potential differences has preset values and associated preset durations, the preset values in the sequence alternate in sign, each preset potential difference represents a preset energy sufficient to release particles 6 present in one of the extreme positions from their position but insufficient to enable said particles 6 to reach the other one of the extreme positions. As an example the appearance of a picture element is light gray before the application of the sequence of preset potential differences. Furthermore, the picture appearance corresponding to the image information of the picture element is dark gray. For this example, the potential difference of the picture element is shown as a function of time in FIG. 9. In the example, the sequence of preset potential differences has 4 preset values, subsequently 15 Volts, −15 Volts, 15 Volts and −15 Volts, applied from time to time t₁. Each preset value is applied for e.g. 20 ms. Subsequently, the reset potential difference has e.g. a value of −15 Volts and is present from time t₁ to time t₂. The reset duration is e.g. 150 ms. As a result, the particles 6 occupy the second extreme position and the picture element has a substantially black appearance. The picture potential difference is present from time t₃ to time t₄ and has e.g. a value of e.g. 15 Volts and a duration of e.g. 50 ms. As a result the picture element 2 has an appearance being dark gray, for displaying the picture. Without being bound to a particular explanation for the mechanism underlying the positive effects of application of the preset pulses, it is presumed that the application of the preset pulses have the same effect as the application of shaking pulses in between reset and grey scale driving potential differences, i.e. it increases the momentum of the electrophoretic particles and thus shortens the switching time, i.e the time necessary to accomplish a switch-over, i.e. a change in appearance. It is also possible that after the display device is switched to a predetermined state e.g. a black state, the electrophoretic particles are “frozen” by the opposite ions surrounding the particle. When a subsequent switching is to the white state, these opposite ions have to be timely released, which requires additional time. The application of the preset pulses speeds up the release of the opposite ions thus the de-freezing of the electrophoretic particles and therefore shortens the switching time.

As explained above, the accuracy of the greyscales in electrophoretic displays is strongly influenced by image history, dwell time, temperature, humidity, lateral inhomogeneity of the electrophoretic foils etc. Using reset pulses accurate grey levels can be achieved since the grey levels are always achieved either from reference black (B) or from reference white state (W) (the two extreme states). The pulse sequence usually consists of three to four portions: first shaking pulses (optionally, hereinfurther also called shake 1), reset pulse (during Pᵣₑₛₑₜ), shaking pulses (P_{shaking}) and greyscale driving pulses (P_{grey scale driving}).

As explained in the above given examples a series of shaking potential differences is used. Application of an reset potential drive the image to a pure black-and-white image which is maintained for some period of time, namely during P_{shaking}. So, starting from an image comprising grey tones and changing over to another image having grey tones, an intermediate image of pure black-and-white is visible. This is visible to the viewer. FIG. 10 illustrates the transition, staring from a grey tone image A at t=start reset period, another grey tone image B is produced at t=end grey scale driving period. An intermediate pure black-and-white image I is visible during P_{shaking}. Below the figure an arbitrary harshness factor H is schematically indicated. During P_{shaking} a harsh image is shown. This is a disturbing effect. It is to be remarked that for instance a slight lateral shift of a grey tone image which otherwise stays the same will produce such an effect. The harsh image is clearly visible. The reason why this pure black-and-white image is visible is explained by way of example in FIG. 11.

The application schemes for four transition, from White (W) to Dark Grey (DG), from Light Grey (LG) to Dark Grey (DG), from Dark grey (DG) to Black (B) and from Black (B) to Dark grey (DG) are shown, one below the other. Each wave form comprises a reset signal, a shaking signal (shake 2), and finally a grey scale potential difference (V,t)_{drive}. At the end of the application of the reset signal the element reaches a final optical state, which in this case is black. This point is indicated by the arrow B. From that point onwards, during shake 2 the element remains in the final state, i.e. it is totally black. Similar figures may be made for a transition via an extreme white optical state. Up until time t=0 the original grey tone image is visible. The elements change to black, and all elements are black at the end of the reset period. At the beginning of the grey scale driving period the optical state of the elements changes again up until the end of the grey scale driving period at which point the grey tone image B is visible. This scheme shows that during shake 2 (P_{shaking}) all elements are black. During this time period a pure black-and-white image is visible. This is schematically shown below the figure.

FIG. 12 shows the scheme of FIG. 11 with one change, the application of the shaking potential difference is delayed by a delay time Δ, in this example by shifting the whole of the pulse trains by a delay time Δ. As can be seen at the bottom of the figure this does not really improve matters, The pure black-and-white image is visible for an equally long time period P_{shaking}, only delayed by the delay Δ. However, although the visible effect for both schemes is the same, a combination of the schemes wherein the elements are divided in two groups that are so distributed over the screen that the human eye sees an average image will reduce the effect.

Schematically this is shown in FIG. 13. The top part shows schematically the harshness index H for the schemes I (FIG. 11) and 11 (FIG. 12), where as explained above for each of the groups separately the disturbing visible effect occurs. When the elements are split in two interspersed groups the total effect is schematically shown in the lower half of FIG. 13, showing a much more gradual change between the images. In this example the delay time is a approximately equal to the shaking period P_{shaking}. To have an effect the delay time is at least 25%, preferably 50% or more, more preferably 75-100% or more of the shaking period. When Δ is approximately equal or greater than P_{shaking} (and two groups are used), then a very gradual change-over may be accomplished.

FIGS. 11 and 12 illustrate a simple embodiment of the invention is which a simple time delay Δ characterizes the difference in waveforms of applied potential differences between the groups. Basically to both groups the same scheme of reset-shaking-grey scale potential difference is applied for each transition, only the pulse trains are shifted. In this example two groups are used. Within the framework of the invention more than two groups may be used, where in general, the more groups are used, the smoother the transition may be made, but the more complicated the electronics.

Such embodiments are relatively simple, but have the disadvantage that as can be seen in FIG. 13, the total transition time is increased, e.g. by the delay time Δ. In the example shown the time difference is a fixed time difference i.e. the same for all transitions, which is a preferred embodiment. It is remarked that in embodiments the time difference could be different for different transitions.

FIG. 14 illustrates an example of an embodiment of the invention in which this is not the case. The schemes I and II illustrate for transitions from an initial state to black where the initial state is White (W), light grey (G2), and dark grey (G1), followed by a transition to the final grey level G1. In both schemes the waveform for the application of the reset potential difference of longest duration (from White (W) to black (B)) is the same, starts at the same time, and ends at the same time. None of the waveforms for other transitions exceed these starting or end points. When comparing the left hand scheme I to the right hand scheme II the onset of the shaking pulses show a shift in time for all but the longest transition (W-to-B-to G1). As a consequence a smoothing effect occurs for all but the longest transitions when two interspersed groups using schemes I and II are used.

In this embodiment the drive means are arranged such that the application schemes between groups (I, II) differ in that a time difference (Δ′) is established between groups for transitions (G2-B, G1-B, B-B) for the onset of the shaking pulses, and for all groups application of a combination of a reset potential difference of maximum time length (W-B) followed by a shaking pulse of length P_{shaking} are synchronized within a maximum time period having a common starting point (tₛₜₐᵣₜ) and an end point (t_{end}), and for all groups and transitions the application of reset potential differences do not extend in time beyond said maximum time period. The time difference may be and preferably is of constant length for all transitions where a time difference is applied. This simplifies the difference between the schemes I and II. In more complex embodiments the time difference may be dependent on the transition. The advantage is that the transition time is not increased, the disadvantage is that more complex driving schemes must be implemented.

It is remarked that FIGS. 11, 12 and 14 illustrate embodiments having negatively charged white particles and positive black particles. For the invention it does not make a difference whether the white particles are negative charged and the black positively or vice versa.

FIG. 15 illustrates the way in which different shaking period P_{shakingI} and P_{shakingII} may overlap or differ. At the top a situation is given, which may be compared to the already given examples in which the length of the shaking period P_{shakingI} and P_{shakingII} is the same, but there is a shift Δ. At the middle of the figure a further possibility is shown in which the shaking periods start at the same time, but half a different length, in this example the length of the shaking period in scheme II is approximately half of that in schemeI. This will also lead to a difference Δ, in this case Δ=0.5P_{shakingI}=P_{shakingII}. Δ is thus more than 25% of the longest shaking time period. At the bottom a similar situation is shown, only the shaking period are synchronized at the end of the shaking periods. In a most extreme example of the situations shown in the middle and lower part of FIG. 15 the length of the shaking period P_{shakingII} would be zero, i.e. in one of the groups shaking pulses would be applied, in the other not.

Especially when the length of the shaking periods is different, then most preferably the schemes are alternated. If the length of the shaking periods differ, the longest shaking period usually is “the right length”, i.e. as long as is needed to get the full effect of the shaking pulses. The shorter (or even absent) shaking pulses, if repeatedly applied to the same group would, in time, lead to a difference in grey scale between the groups. By alternating the schemes between groups this effect is removed, since, average over a several image transitions, all elements receives the same shaking pulses.

The application of shaking potential differences that differ between groups, has the above described positive effect of reducing the harshness of the image change-over. Although using the devices and methods in accordance with the invention a more smooth image transition is provided, it is best if, seen on a longer time scale, all groups have substantially the same history of application of shaking signals. By alternating the schemes for application of shaking signals between the groups between images, the differences between the groups are minimized. So, if for instance two groups (A, B) are used, and two schemes I and II are used for application of shaking potential difference, in the first frame scheme I is used for group A, and scheme II for group B, and in the next frame scheme II for group A and scheme II for group B, returning to scheme I for group A and scheme II for group B in the next frame etc. With more than two groups permutation or rotation of the schemes would be used, which within the concept of the invention falls under “alternating”. Within preferred embodiments the schemes are alternated with each change of a frame, however, within the broader concept of the invention, the schemes may be alternated each n frames, wherein n is a small number such as 1, 2, 3. The advantage of alternating every second or third frame instead of every frame is that it is simpler.

It is remarked that the plurality of display elements divided into interspersed groups may cover all of the display screen of the display device and often will do so, but such is not necessary within a broad concept of the invention, it may relate to a part of a larger screen. For instance if there is a first part of the display screen for which the image changes regularly and comprises grey tones (e.g. to photographs), while another part of the display screen is used to display pure black and white images (black text on a white background for instance), the invention may be used for the first part, and not for the second part of the display screen.

In short the invention may be described as follows:

An electrophoretic display panel (1), comprises a plurality of picture elements (2); and drive means (100), for providing reset pulses prior to application of grey scale pulses and shaking pulses in between application of reset and grey scale pulses. The display panel comprises two or more interspersed groups of display elements. Each group is supplied with its own scheme (I, II) of shaking potential differences, the application schemes for shaking potential differences differs from group to group in such manner that the occurrence of the shaking pulses differs between said groups for at least some transitions.

It is remarked that the division in groups may be fixed and the allocation of schemes to groups may be fixed, for instance wherein a first scheme of shaking pulses is supplied to even rows of display elements, and a second, different, scheme is used for odd rows, the groups may be fixed but the allocation may vary, for instance between frames, but also the groups need not be fixed, for instance wherein in one frame a division is made in two groups, comprising odd rows and even rows respectively, in the next frame three groups are used, etc. etc.

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The invention is also embodied in any computer program comprising program code means for performing a method in accordance with the invention when said program is run on a computer as well as in any computer program product comprising program code means stored on a computer readable medium for performing a method in accordance with the invention when said program is run on a computer, as well as any program product comprising program code means for use in display panel in accordance with the invention, for performing the action specific for the invention.

The present invention has been described in terms of specific embodiments, which are illustrative of the invention and not to be construed as limiting. The invention may be implemented in hardware, firmware or software, or in a combination of them. Other embodiments are within the scope of the following claims.

1. An electrophoretic display panel (1),
comprising:
an electrophoretic medium (5) comprising charged particles (6);
a plurality of picture elements (2);
electrodes (3,4) associated with each picture element (2) for receiving a potential difference,
the charged particles being able to occupy extreme positions near the electrodes and intermediate positions in between the electrodes; the extreme positions being associated with extreme optical states; and
drive means (100),
the drive means (100) being arranged for providing to each of the plurality of picture elements (2)
a reset potential difference having a reset value and a reset duration for causing the charged particles (6) to substantially occupy one of the extreme positions, and thereafter
a grey scale potential difference for causing the particles (6) to occupy the position corresponding to the image information, and
a series of shaking potential differences during a shaking time period (P_{shaking}) in between application of the reset potential difference and the grey scale potential difference, wherein the plurality of picture elements comprises two or more interspersed groups (A, B) of picture elements, and the drive means (100) are arranged to provide each group of picture elements with its own application scheme (I, II) of shaking potential differences, the application schemes (I, II) for shaking potential differences differing from group to group in such a manner that the shaking time periods (P_{shaking}) at which the shaking potential differences are applied to said groups (A, B) do not, during a time difference (Δ), completely coincide for at least some transitions of a picture element from an initial optical state to a final optical state via an extreme optical state, the time difference (Δ) being at least 25% of the longest shaking time period for the respective groups (Δ≧0.25P_{shaking}).

2. An electrophoretic display device as claimed in claim 1, characterized in that the time difference (Δ) is at least 50% of the longest shaking time period (Δ≧0.5P_{shaking}).

3. An electrophoretic display device as claimed in claim 1, wherein the drive means (100) are arranged to provide shaking potential differences such that the application schemes (I, II) for application of the shaking potential differences alternate between groups (A, B) between frames.

4. An electrophoretic display device as claimed in claim 1, wherein the shaking time periods (P_{shakingI}, P_{shakingII}) for the groups are of equal length.

5. An electrophoretic display device as claimed in claim 1, wherein the shaking time periods for different groups differ (P_{shakingI}≠P_{shakingII}).

6. An electrophoretic display panel as claimed in claim 1, wherein the drive means are arranged to provide each group with its own shaking potential differences, the application schemes (I, II) for shaking potential differences differing from group to group by a fixed time difference independent of the transition (Δ).

7. An electrophoretic display panel as claimed in claim 1, wherein the drive means are arranged such that the application schemes (I, II) between groups of picture elements differ in that a time difference (Δ′) is established between groups for those transitions (G2-B, G1-B, B-B), in which the combination of a reset potential difference followed by a shaking pulse is applied during less than a maximum period, but, for all groups of elements application of a combination of a reset potential difference of maximum time length (W-B) followed by a shaking pulse are synchronized within a maximum time period having a common starting point (tₛₜₐᵣₜ) and an end point (t_{end}), and for all groups and transitions the application of reset potential differences does not extend beyond said maximum time period (tₛₜₐᵣₜ−t_{end}).

8. A method for driving an electrophoretic display devices comprising a plurality of picture elements in which method reset potential differences are applied to picture elements of the display device, prior to application of grey scale potential differences to said picture elements, wherein in between application of reset potential difference and grey scale potential difference shaking potential differences are applied during a shaking time period (P_{shaking}) wherein the plurality of picture elements comprises two or more interspersed groups of picture elements, and each group (A, B) of picture elements is supplied with its own application scheme (I, II) of shaking potential differences, the application schemes for shaking potential differences differing from group to group in such a manner that the shaking time periods (P_{shaking}) at which the shaking potential differences are applied to said groups (A,B) do not, during a time difference (Δ), completely coincide for at least some transitions of a picture element from an initial optical state to a final optical state via an extreme optical state, the time difference (Δ) being at least 25% of the longest shaking time periods for the respective groups (Δ≧0.25P_{shaking}).

9. A method as claimed in claim 8, wherein the shaking potential differences are applied such that the application schemes for application of the shaking signals alternate between groups between frames.

10. A method as claimed in claim 8, wherein each group is supplied with its own scheme for shaking potential difference, the application schemes for shaking potential differences differing from group to group by a fixed time difference independent of the transition (Δ).

11. Computer program comprising program code means for performing a method in accordance with the method as claimed in claim 8 when said program is run on a computer.

12. Computer program product comprising program code means stored on a computer readable medium for performing a method in accordance with the method as claimed in claim 8 when said program is run on a computer.
